(19) United States
(12) Patent Application Publication
(10) Pub. No.: US 2016/0295456 A1
(43) Pub. Date: Oct. 6, 2016

(54) DATA COMPRESSION IN WIRELESS COMMUNICATIONS NETWORK

(71) Applicant: TELEFONAKTIEBOLAGET LM ERICSSON (PUBL), Stockholm (SE)

(72) Inventors: Jiangtao ZHANG, SAN JOSE, CA (US); Bengt JOHANSSON, Västra Frölunda (SE); Sten PETTERSSON, Torslanda (SE)

(73) Assignee: TELEFONAKTIEBOLAGET LM ERICSSON (PUBL), Stockhom (SE)

(21) Appl. No.: 15/037,248

(22) PCT Filed: Nov. 19, 2013
(86) PCT No.: PCT/CN2013/087382

§ 371 Date: May 17, 2016

(51) Int. Cl. H04W 28/06; H04W 8/04; H04M 7/00; H04J 11/00; H04W 24/02; H04L 29/12; H04L 1/00

(52) U.S. Cl. CPC H04W 28/06; H04L 61/6054; H04W 8/04; H04L 1/0018; H04J 11/0023; H04J 11/00; H04W 24/02; H04L 61/6086; H04M 7/006; H04W 88/08

(57) ABSTRACT

The invention relates to a method and network node for compressing data intended for a radio terminal in a wireless communication network. The network node (14) according to embodiments of the present invention for compressing data intended for a radio terminal (10) in a wireless communications network, which network node handles payload data in a RAN or a core network of the wireless communications network, comprises a processing unit (15) and a memory (16), which memory contains instructions executable by the processing unit, whereby the network node is operative to receive a request for the data and an indication of compression schemes supported by the radio terminal, and to forward the request for the data received from the radio terminal to a provider (19) of the data. Further the network node is operative to receive the requested data from the provider of the data, to compress the received data with a compression scheme being supported by the radio terminal and to send the compressed data to the radio terminal.

### TECHNICAL FIELD The invention relates to a method and a network node for compressing data intended for a radio terminal in a wireless communication network.

### BACKGROUND

In wireless communication networks, bit error rate may be high due to interference, and latency may be high due to long round trips. It is important for network operators to utilize the wireless resources and other network resources efficiently to attain higher bandwidth in their wireless networks. For example, in Long Term Evolution (LTE) networks, a radio terminal such as a User Equipment (UE) uses numerous Hyptertext Transfer Protocol (HTTP) applications, for instance HyperText Markup Language (HTML) and Extensible Markup Language (XML) applications, web based entertainment, network societies, games, chats, etc., e.g. to support clients running on Android and/or iOS based smart phones or tablets or similar. Optimization of HTTP-based communication would save resources in the LTE core network, referred to as Evolved Packet Core (EPC) network, and in the radio access network known as the Evolved Universal Mobile Telecommunications System (UMTS) Radio Access Network (E-UTRAN), which handles packets sent between a UE and e.g. a web server. It should be noted that optimization of HTTP-based communication would save resources in the corresponding radio access network and in the core network of telecommunication networks, e.g. such as Global System for Mobile communications (GSM) and UMTS, or other 3G systems such as CDMA2000 (“Code Division Multiple Access”) and EVolution-Data Optimized (EVDO) networks.

In the art, both Internet Protocol (IP) header compression as well as data (i.e. payload) compression is employed. For instance, in Internet Protocol version 4 (IPv4) the header size is 40 bytes, and in Internet Protocol version 6 (IPv6), it is 60 bytes, which in the case of e.g. Voice over IP (VoIP) accounts for about 60% of the packet size, the remaining part being payload data. This is unacceptably high in wireless communication networks, and the IP header is compressed down to 1 and three bytes for IPv4 and IPv6, respectively. Thus, a data packet comprising about 40 bytes in IPv4 is compressed down to 21 bytes, where 20 bytes are payload data, before being sent over a so called Uu interface between the UE and an Evolved NodeB (eNodeB).

HTTP data compression is also used for transmission of payload data e.g. between a client in a UE and for instance a web server via the EPC network. Since most of the HTTP data relates to HTTP, Cascading Style Sheets (CSS) and JavaScript, i.e. text formats having a rate of repeated tags and symbols, the compression rate is between 30-70%.

FIG. 1 illustrates a prior art process of a web client in an UE accessing a web server via an EPC network and a commonly used intermediate node, e.g. being a proxy server. The UE sends an HTTP request to the EPC network. The request comprises information indicating one or more types of compression schemes accepted by the UE, e.g.the commonly used gzip, deflate, Shared Dictionary Compression over HTTP (SDCH), etc. The EPC network forwards the HTTP request to the proxy server. The HTTP request may for instance be a request to access a web page on the web server. The proxy server forwards the HTTP request to the web server, which responds to the HTTP request with an HTTP response comprising HTTP data compressed with one of the compression schemes supported by the UE. Subsequently, the HTTP response comprising the compressed HTTP data is forwarded by the proxy server to the UE via the EPC network.

FIG. 2 illustrates a further prior art process of a web client in a UE accessing a web server via an EPC network and a proxy server. The UE sends an HTTP request to the EPC network. The request comprises information indicating one or more types of compression schemes accepted by the UE, e.g. gzip, deflate or SDCH or similar. The EPC network forwards the HTTP request to the proxy server. The HTTP request may for instance be a request to access a web page on the web server. Now, the proxy server may be incapable of handling compressed data for a number of reasons, such as firewalls, deep packet inspection (DPI) routines, proposed compression schemes(s) not supported, anti-virus software not accepting compressed data, etc. The HTTP request is thus sent from the proxy server to the web server indicating that compression is not supported by the proxy server. This causes the web sever to submit an HTTP response comprising uncompressed data to the proxy server. Subsequently, the HTTP response comprising the uncompressed data is forwarded by the proxy server to the UE via the EPC network.

FIG. 3 illustrates yet another prior art process of a web client in an UE accessing a web server via an EPC network and a commonly used intermediate node, again e.g. being a proxy server. The UE sends an HTTP request indicating types of compression schemes accepted by the UE to the EPC network which forwards the HTTP request to the proxy server. The HTTP request may for instance be a request to access a web page on the web server. In this example, the intermediate node is capable of handling compressed data and indicates the compression schemes in its HTTP request. However, the web server may be incapable of handling compressed data, e.g. for the same reasons as given for the proxy server in connection to FIG. 2, and thus responds to the HTTP request with an HTTP response comprising uncompressed data. Subsequently, the HTTP response comprising the uncompressed data is forwarded by the proxy server to the UE via the EPC network.

Both examples illustrated in FIGS. 2 and 3 will cause the web client in the UE to fall back to an uncompressed HTTP mode, which will cause a great loss in bandwidth in the wireless communication network.

### SUMMARY

It is an object of the present invention to solve, or at least mitigate one or more problems associated with the prior art solutions and to provide an improved method and device for compressing data intended for a radio terminal in a wireless communications network.

This object is attained in a first aspect of the present invention by a method of compressing data intended for a radio terminal in a wireless communications network. The method comprises receiving, at a network node handling payload data in a RAN or in a core network of the wireless communications network, a request for the data and an indication of one or more compression schemes supported by the radio terminal, and forwarding the request for the data received from the radio terminal to a provider of the data. Further, the method comprises receiving the requested data from the provider of the data, compressing the received data with a compression scheme being supported by the radio terminal, and sending the compressed data to the radio terminal.

This object is attained in a second aspect of the present invention by a network node configured to compress data intended for a radio terminal in a wireless communications network, which network node handles payload data in a RAN or a core network of the wireless communications network. The network node comprises a processing unit and a memory, which memory contains instructions executable by the processing unit, whereby the network node is operative to receive a request from the radio terminal for the data and an indication of one or more compression schemes supported by the radio terminal, and to forward the request for the data received from the radio terminal to a provider of the data. Further the network node is operative to receive the requested data from the provider of the data, to compress the received data with a compression scheme being supported by the radio terminal and to send the compressed data to the radio terminal.

Advantageously, by implementing data compression in a RAN of a wireless communications network, instead of e.g. at a web server and/or at an intermediate server (e.g. proxy server) with which a radio terminal communicates for receiving the data, it is possible to attain a better air interface wireless bandwidth usage, even when the data is uncompressed from the web server. Similarly, by implementing data compression in a core network node of a wireless communications network, instead of e.g. at a web server and/or at an intermediate server with which a radio terminal communicates for receiving the data, it is possible to attain a better bandwidth usage within both the core network and in the air interface, even when the data is uncompressed from the web server. Thus, in contrast to discussed prior art, with the present invention, a web client in a radio terminal accessing a web server does not have to fall back to an uncompressed mode in a situation where the web server does not support a compressed mode.

In addition, when the compression function is implemented in a core network node comprising a Policy and Charging Enforcement Function (PCEF) or similar, e.g. in a core network node such as a Packet Data Network Gateway (PGW) or a Gateway General Packet Service Support Node (GGSN), there is already a DPI functionality implemented in the node, which makes the node particularly suitable for implementing such features as a HTTP payload flow detection and compression etc. Moreover, if compression is implemented in a network access gateway, e.g. such as a PGW or a GGSN, then better bandwidth usage can be attained in the whole core network and also in the air interface of the RAN. As a contrast, there is usually a negative impact on the performance of RAN node (e.g. the eNodeB) when DPI related functions are implemented therein, since there are typically no or limited DPI functions in the RAN nodes.

The method and device of embodiments of the present invention may advantageously be implemented in a number of different wireless communications networks.

In an embodiment, the wireless communications network is an LTE network, and the network node handling payload data comprises any one selected from a group comprising a Serving Gateway (SGW), a PGW, and an eNodeB.

In another embodiment, the wireless communications network is a UMTS, network, and the network node handling payload data comprises any one selected from a group comprising a Serving General Packet Service Support Node (SGSN), a GGSN, a Radio Network Controller (RNC) and a NodeB.

In still another embodiment, the wireless communications network is a GSM network, and the network node handling payload data comprises any one selected from a group comprising a SGSN, GGSN, a Base Station Controller (BSC) and a Base Transceiver Station (BTS).

Various embodiments of the present invention will be defined in the detailed description. It is to be noted that the present invention can be implemented in numerous radio communication systems, such as e.g. in an access point or gateway node in a Wireless Local Area Network (WLAN).

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIGS. 1-3 illustrate prior art processes of a UE accessing a web server via an EPC network and an intermediate node;

FIG. 4a shows a schematic overview of an exemplifying wireless communication system in which the present invention can be implemented;

FIG. 4b shows a simplified version of the wireless communication system in FIG. 4a in which a network node according to an embodiment of the present invention communicates with a proxy server and a web server;FIG. 5 illustrates a flow chart of an embodiment of the method according to the present invention; and

FIG. 6 shows a network node handling payload data in a RAN or core network of wireless communications network according to an embodiment of the present invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

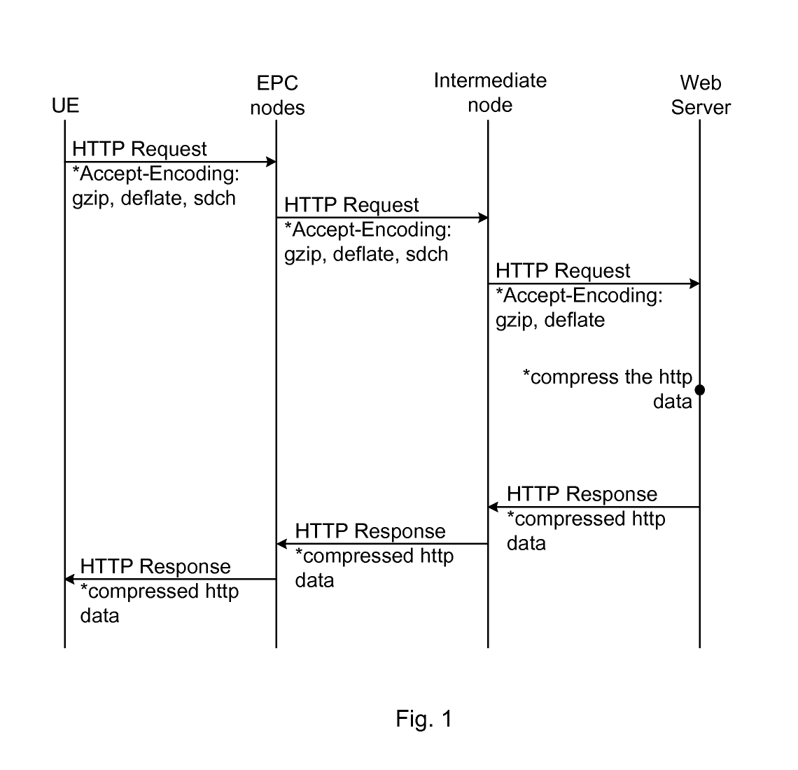

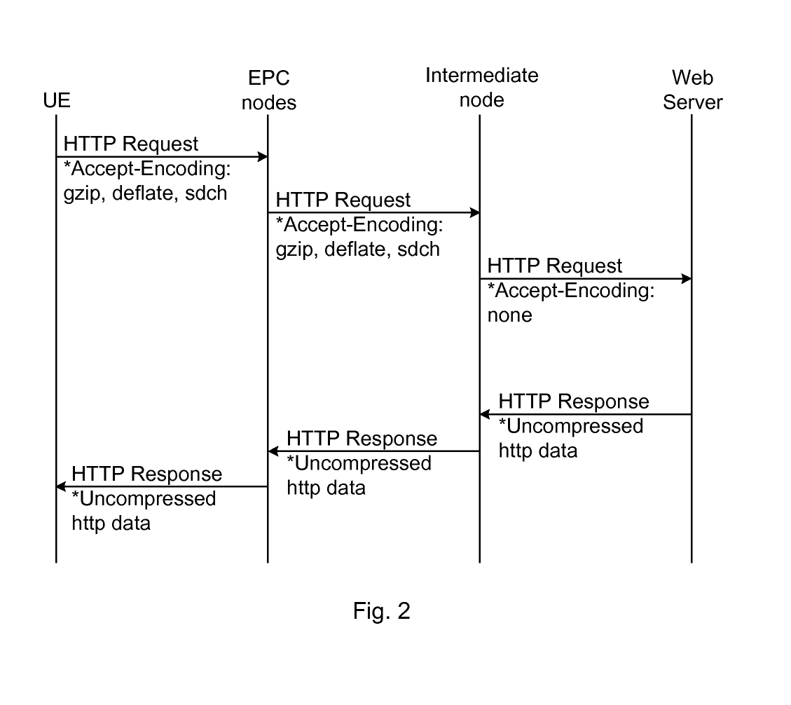

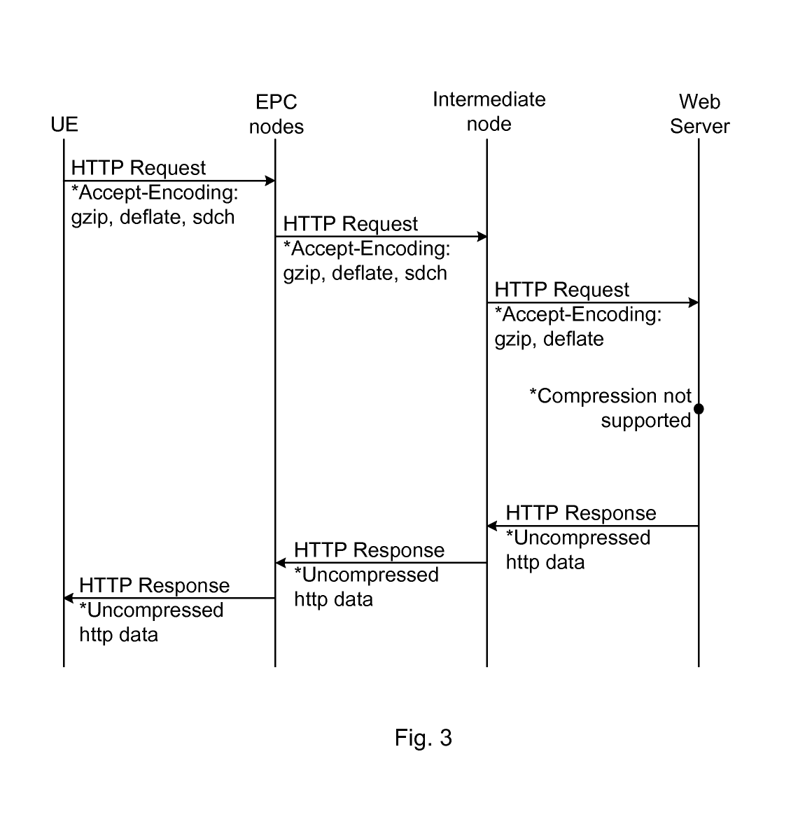

FIGS. 1-3 illustrate prior art processes of a UE accessing a web server via an EPC network and a commonly used intermediate node, being for example a proxy server, as previously has been described.

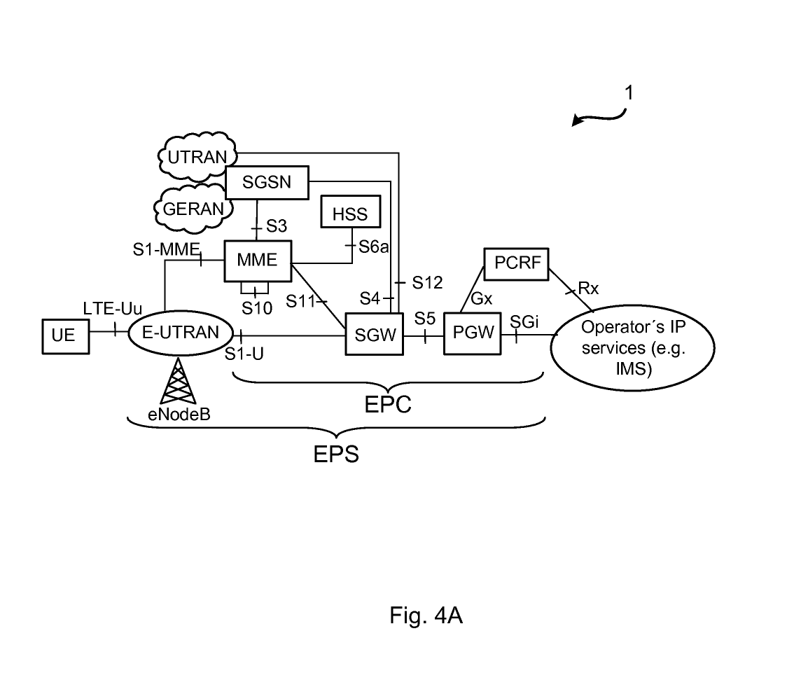

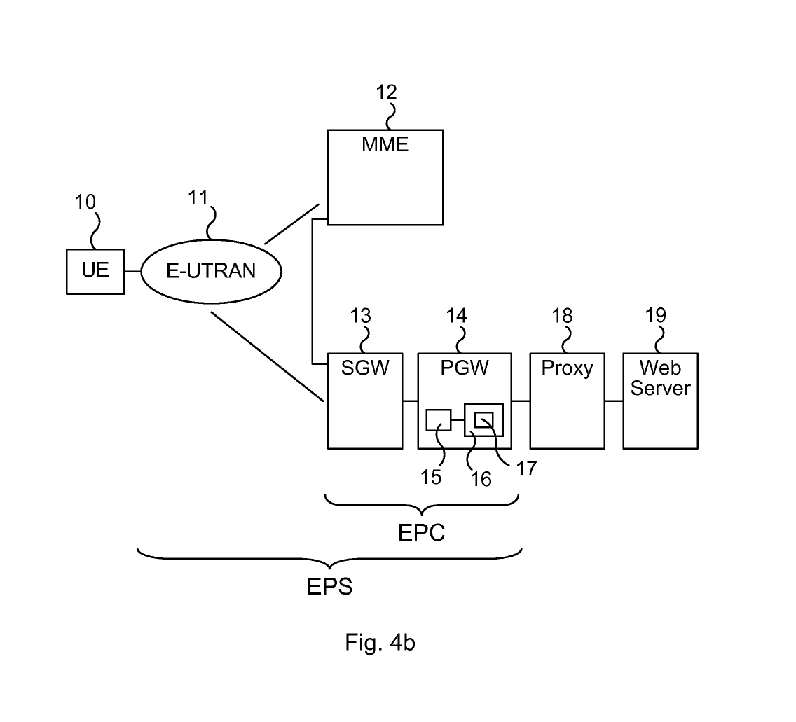

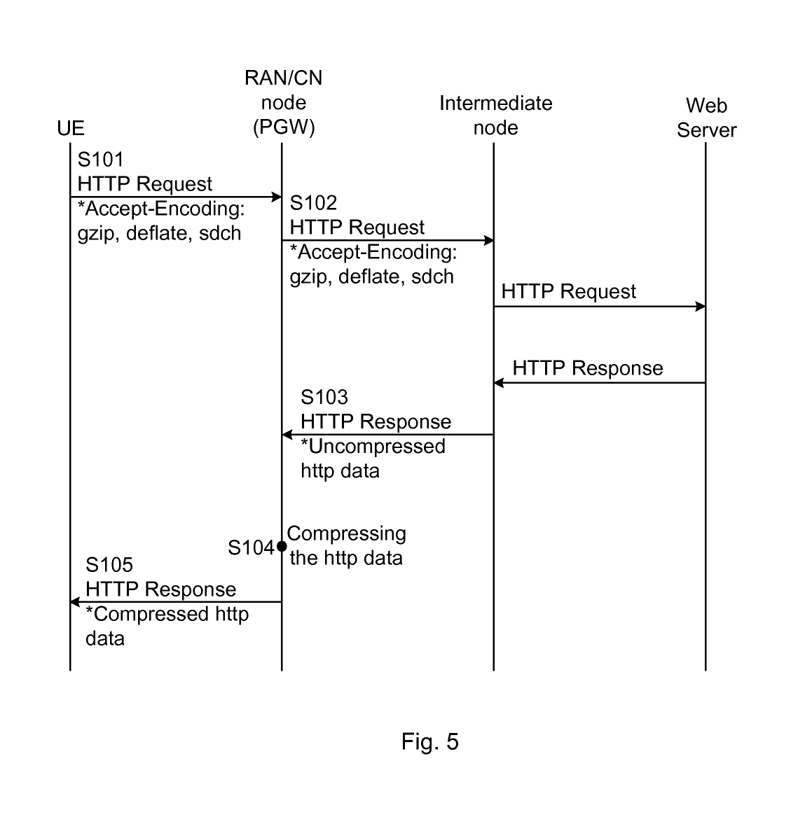

FIG. 4a shows a schematic overview of an exemplifying wireless communication system 1 in which the present invention can be implemented. The wireless communication system 1 is an LTE based system. It should be pointed out that the terms “LTE” and “LTE based” system is here used to comprise both present and future LTE based systems, such as, for example, advanced LTE systems. It should be appreciated that although FIG. 4a shows a wireless communication system 1 in the form of an LTE based system, the example embodiments herein may also be utilized in connection with other wireless communication systems, e.g. such as GSM or UMTS, comprising nodes and functions that correspond to the nodes and functions of the system in FIG. 4a.

The wireless communication system 1 comprises a base station in the form of an eNodeB, operatively connected to an SGW, in turn operatively connected to a Mobility Management Entity (MME) and a PGW, which in turn is operatively connected to a Policy and Charging Rules Function (PCRF). The eNodeB is a radio access node that interfaces with a mobile radio terminal, e.g. a UE. The eNodeBs of the system forms the radio access network E-UTRAN for LTE communicating with the UEs over an air interface such as LTE-Uu. The core network in LTE is known as EPC, as previously discussed, and the EPC together with the E-UTRAN is referred to in LTE as Evolved Packet System (EPS).

The SGW routes and forwards user data packets over the S1-U interface, whilst also acting as the mobility anchor for the user plane during inter-eNodeB handovers and as the anchor for mobility between LTE and other 3 rd Generation Partnership Project (3GPP) technologies (terminating S4 interface and relaying the traffic between 2G/3G systems and PGW). For idle state UEs, the SGW terminates the DL data path and triggers paging when DL data arrives for the UE, and further manages and stores UE contexts, e.g. parameters of the IP bearer service, network internal routing information. It also performs replication of the user traffic in case of lawful interception. The SGW communicates with the MME via the S11 interface and with the PGW via the S5 interface. Further, the SGW may communicate with the UMTS radio access network UTRAN and with the GSM EDGE (“Enhanced Data rates for GSM Evolution”) Radio Access Network (GERAN) via the 512 interface.

The MME is responsible for idle mode UE tracking and paging procedure including retransmissions. It is involved in the bearer activation/deactivation process and is also responsible for choosing the SGW for a UE at the initial attach and at time of intra-LTE handover involving core network node relocation. It is responsible for authenticating the user by interacting with the

Home Subscriber Server (HSS). The Non-Access Stratum (NAS) signaling terminates at the MME and it is also responsible for generation and allocation of temporary identities to UEs via the S1-MME interface. It checks the authorization of the UE to camp on the service provider's Public Land Mobile Network (PLMN) and enforces UE roaming restrictions. The MME is the termination point in the network for ciphering/integrity protection for NAS signaling and handles the security key management. Lawful interception of signaling is also supported by the MME. The MME also provides the control plane function for mobility between LTE and 2G/3G access networks with the S3 interface terminating at the MME from the SGSN. The MME also terminates the Sha interface towards the home HSS for roaming UEs. Further, there is an Sio interface configured for communication between MMEs for MME relocation and MME-to-MME information transfer.

The PGW provides connectivity to the UE to external packet data networks (PDNs) by being the point of exit and entry of traffic for the UE. A UE may have simultaneous connectivity with more than one PGW for accessing multiple PDNs. The PGW performs policy enforcement, packet filtering for each user, charging support, lawful Interception and packet screening. Another key role of the PGW is to act as the anchor for mobility between 3GPP and non-3GPP technologies such as WiMAX and 3GPP2 (CDMA 1X and EvDO). The interface between the PGW and the packet data network is referred to as the SGi. The packet data network may be an operator external public or private packet data network or an intra operator packet data network, e.g. for provision IP Multimedia Subsystem (IMS) services.

The PCRF determines policy rules in real-time with respect to the radio terminals of the system. This may e.g. include aggregating information in real-time to and from the core network and operational support systems, etc.

of the system so as to support the creation of rules and/or automatically making policy decisions for user radio terminals currently active in the system based on such rules or similar. The PCRF provides the PGW with such rules and/or policies or similar to be used by the acting PGW as a Policy and Charging Enforcement Function (PCEF) via interface Gx. The PCRF further communicates with the packet data network via the Rx interface.

FIG. 4b shows a simplified version of an LTE system of the type discussed in detail in FIG. 4a. As can be seen in FIG. 4b, the LTE system communicates with a proxy server 18 and a web server 19. FIG. 4b illustrates an LTE based wireless communications network in which an embodiment of the present invention is implemented. The LTE based system comprises a radio terminal in the form of a UE 10 communicating via a RAN in the form of an E-UTRAN ii including one or more eNodeBs (not shown in FIG. 4b) and an SGW 13 and a device according to an embodiment of the present invention for compressing data intended for the UE 10. In this exemplifying embodiment of the present invention the device is implemented in the form of a PGW 14. In practice, the method in the PGW 14 may be performed by a processing unit 15 embodied in the form of one or more microprocessors arrangements configured to execute a computer program 17 downloaded to a suitable storage medium 16 associated with the microprocessor arrangement, e.g. such as a Random Access Memory (RAM), a Flash memory or a hard disk drive. The processing unit 15 is arranged to carry out the method according to embodiments of the present invention when the appropriate computer program 17 comprising computer-executable instructions is downloaded to the storage medium 16 and executed by the processing unit 15. The storage medium 16 may also be a computer program product comprising the computer program 17. Alternatively, the computer program 17 may be transferred to the storage medium 16 by means of a suitable computer program product, such as a floppy disk or a memory stick. As a further alternative, the computer program 17 may be downloaded to the storage medium 16 via the LTE based wireless communications network or similar. The processing unit 15 may alternatively be embodied in the form of a digital signal processor (DSP), an application specific integrated circuit (ASIC), a field-programmable gate array (FPGA), a complex programmable logic device (CPLD), etc. The PGW 14 of the wireless communications network may further communicate with a web server 19 via an intermediate node, e.g. such as a proxy 18, as will be discussed in more detail in the following.

FIG. 5 illustrates a flow chart of a method according to an embodiment of the present invention, where the method is exemplified to be undertaken in a node handling payload data in the E-UTRAN or the EPC of an LTE wireless communications network, i.e. in a payload data-handling network node (see FIGS. 4a-b). The EPS node could be embodied by any one of the SGW, the PGW or the eNodeB, preferably the PGW as discussed above with reference to FIG. 4b. Thus, the PGW 14 receives in a first step S101 an HTTP request from a UE 10 (e.g. from a client in the UE) wishing to access a web server 19 or similar. In this example the web server 19 is accessed via a commonly used intermediate node, being for example a proxy server 18. The method could be applied also in a system lacking an intermediate node 18 between the PGW 14 and the web server 19. The HTTP request received by the PGW 14 in step Sioi further comprises information indicating one or more compression schemes accepted by the UE 10, for instance gzip, deflate, SDCH, etc. The PGW 14 forwards the received HTTP request including the compression schemes to the proxy server 18 in step S102, which in its turn forwards the HTTP request including the compression schemes to the web server 19. If any one of the intermediate node 18 or the web server 19 (or both) is incapable of compressing HTTP data according a common compression scheme supported by the UE, then the HTTP response received in step S103 at the PGW 14 from the web server 19 via the proxy server 18 comprises uncompressed HTTP data, as previously has been discussed in the Background with reference to FIGS. 1-3. It is preferred that the PGW 14 detects that the received data is uncompressed. This can e.g. be done by means of packet inspection or by inspecting a flag included (by the web server 19 or the proxy 18) in the HTTP response indicating whether the HTTP data is compressed or not. The PGW 14 will then look up which compression schemes the UE 10 supports, e.g. based on the information received from the UE 10 in step Sim, and compress the data received in the HTTP response from the proxy server 18 using an appropriate compression scheme in step S104. Finally, in step S105, the PGW 14 sends the compressed data in an HTTP response to the UE 10, possibly together with information indicating the compression scheme used for the compressed data.

FIG. 5 exemplifies an embodiment of the present invention being implemented in an LTE network. However, in another embodiment of the present invention, the wireless communications network is a UMTS network, and the network node handling payload data is any one selected from a group comprising the SGSN, the GGSN, the RNC and the NodeB. In still another embodiment of the present invention, the wireless communications network is a GSM network, and the network node handling payload data is any one selected from a group comprising a SGSNC, a GGSN, a BSC and a BTS.

Advantageously, by implementing the HTTP data compression in an EPS network node (in case of LTE) such as the PGW 14, instead of e.g. at the web server 18 (which is not part of the EPS), it is possible to attain a better Uu interface wireless bandwidth usage, and better bandwidth in the EPC, e.g. in the S1-U interface even when the HTTP data is uncompressed from the web server/proxy server. Thus, in contrast to discussed prior art, a web client in the UE 10 accessing the web server 19 does not have to fall back to an uncompressed HTTP mode in a situation where the intermediate node 18 and/or the web server 19 does not support a compressed HTTP mode.

In an embodiment, the HHTP data compression method according to embodiments of the present invention is implemented at the gateway node, e.g. such as the PGW 14, being capable of DPI and packet classification. DPI pertains inspection of data packet content, e.g. for identifying the kind of data being sent whether it is a VoIP packet, an e-mail, streaming data, gaming data, etc., in order to determine what actions to be taken on the data. After having performed DPI, it is efficient if the gateway node also performs the HTTP data compression before sending the compressed data downlink towards the radio terminal (e.g. UE io). Further, this embodiment is advantageous since the gateway node, e.g. PGW 14, generally extracts the supported compression schemes from the HTTP request initially sent by the radio terminal in an uplink direction. Yet another advantage is that the compression scheme used is independent of a preferred compression scheme of the web server 19.

With further reference to FIG. 5, in an embodiment of the present invention, step S105, i.e. the PGW 14 sending in an HTTP response the compressed data to the UE 10 further comprises adding, to the compressed data being sent to the radio terminal, information identifying the compression scheme used by the PGW.

It should be noted that if the web server 19 sends compressed HTTP data to a web client of the UE 10, the PGW 14 will preferably not perform any compressing of HTTP data. Further, if the web client on the UE 10 sends an HTTP request without indicating a supported compression scheme, or if an indicated compression scheme is not supported by PGW 14, the compression scheme information will typically not be stored at the PGW.

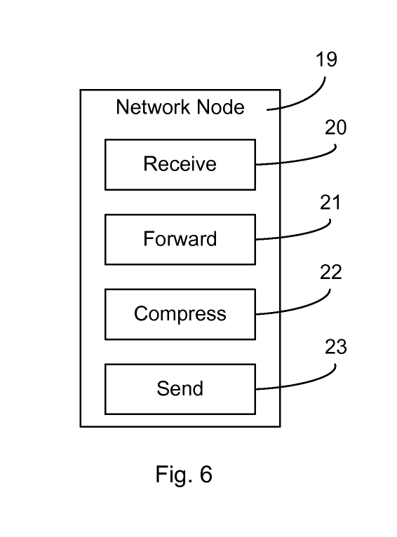

FIG. 6 shows a network node 14 handling payload data in a RAN or core network of a wireless communications network according to an embodiment of the present invention. The network node 14 comprises receiving means 20 adapted to receive a request for data and an indication of compression schemes supported from a radio terminal, and forwarding means 21 adapted to forward the request for the data received from the radio terminal to a provider of the data. Further, the receiving means 20 is adapted to receive the requested data from the provider of the data. Moreover, the network node 14 comprises compressing means 22 adapted to compress the received data with a compression scheme being supported by the radio terminal, and sending means 23 adapted to send the compressed data to the radio terminal. The receiving means 20, forwarding means 21 and sending means 23 may comprise a communications interface for receiving information from the radio terminal and forwarding/sending information to the provider of data. The various interfaces have been described in detail with reference to FIG. 4a. The network node 14 may further comprise a local storage. The receiving means 20, forwarding means 21, compressing means 22 and sending means 23 may (in analogy with the description given in connection to FIG. 4b) be implemented by a processor embodied in the form of one or more microprocessors arranged to execute a computer program downloaded to a suitable storage medium associated with the microprocessor. The receiving means 20, forwarding means 21 and sending means 23 may comprise one or more transmitters and/or receivers and/or transceivers, comprising analogue and digital components and a suitable number of antennae for radio communication, and could even be comprised in the same functional unit, such as a transceiver.

Some embodiments of the present invention described above may be summarized in the following manner:

Some embodiments are directed to a method for compressing data intended for a radio terminal in a wireless communications network, the method comprising: receiving, at a network node handling payload data in a radio access network, RAN, or in a core network of the communications network, a request from the radio terminal for the data and an indication of one or more compression schemes supported by the radio terminal; forwarding the request for the data received from the radio terminal to a provider of the data; receiving the requested data from the provider of the data; compressing the received data with a compression scheme being supported by the radio terminal; and sending the compressed data to the radio terminal.

The wireless communications network may be a Long Term Evolution, LTE, network, and the network node handling payload data may be any one selected from a group comprising a Serving Gateway, SGW, a Packet Data Network Gateway, PGW, and an Evolved NodeB, eNodeB.

The method wireless communications network may be a Universal Mobile Telecommunication System, UMTS, network, and the network node handling payload data may be any one selected from a group comprising a Serving

General Packet Service Support Node, SGSN, a Gateway General Packet Service Support Node, GGSN, a Radio Network Controller, RNC, and a NodeB.

The wireless communications network may be a Global System for Mobile communications, GSM, network, and the network node handling payload data may be any one selected from a group comprising a Serving General Packet Service Support Node, SGSN, a Gateway General Packet Service

Support Node, GGSN, a Base Station Controller, BSC, and a Base Transceiver Station, BTS.

The request received at the network node may be a Hypertext Transfer Protocol, HTTP, request.

The compression scheme may be any one selected from a group comprising gzip, deflate and Shared Dictionary Compression over HTTP, SDCH.

The compression of the received data may be performed in connection with undertaking Deep Packet Inspection, DPI, at the network node.

The compressed data may be sent to the radio terminal, information identifying the compression scheme used by the network node.

Some embodiments of the present invention described above may be summarized in the following manner:

Some embodiments are directed to a network node configured to compress data intended for a radio terminal in a wireless communications network, said network node handling payload data in a radio access network, RAN, or a core network of the wireless communications network and comprising a processing unit and a memory, said memory containing instructions executable by said processing unit, whereby said network node is configured to: receive a request from the radio terminal for the data and an indication of one or more compression schemes supported by the radio terminal; forward the request for the data received from the radio terminal to a provider of the data; receive the requested data from the provider of the data; compress the received data with a compression scheme being supported by the radio terminal; and send the compressed data to the radio terminal.

The wireless communications network may be a Long Term Evolution, LTE, network, and the network node handling payload data may be any one selected from a group comprising a Serving Gateway, SGW, a Packet Data Network Gateway, PGW, and an Evolved NodeB, eNodeB.

The wireless communications network may be a Universal Mobile Telecommunication System, UMTS, network, and the network node handling payload data may comprise any one selected from a group comprising a Serving General Packet Service Support Node, SGSN, a Gateway General Packet Service Support Node, GGSN, a Radio Network Controller, RNC, and a NodeB.

The wireless communications network may be a Global System for Mobile communications, GSM, network, and the network node handling payload data may comprise any one selected from a group comprising a Gateway Mobile Switching Center, GMSC, a Mobile Switching Center, MSC, a Base Station Controller, BSC, and a Base Transceiver Station, BTS.

The request received may be a Hypertext Transfer Protocol, HTTP, request.

The compression scheme may be any one selected from a group comprising gzip, deflate and Shared Dictionary Compression over HTTP, SDCH.

The compression of the received data may be performed in connection with undertaking Deep Packet Inspection, DPI, at the network node.

The network node may be further configured to: add, to the compressed data being sent to the radio terminal, information identifying the compression scheme used by the network node.

The invention has mainly been described above with reference to a few embodiments. However, as is readily appreciated by a person skilled in the art, other embodiments than the ones disclosed above are equally possible within the scope of the invention, as defined by the appended patent claims.

1. A method of compressing data intended for a radio terminal in a wireless communications network, comprising:
receiving, at a network node handling payload data in a radio access network, RAN, (RAN) or in a core network of the communications network, a request from the radio terminal for the-data and an indication of one or more compression types supported by the radio terminal;
forwarding the request for data received from the radio terminal to a provider of the data;
receiving the requested data from the provider of the data;
after receiving the requested data, compressing the received data with a compression type being supported by the radio terminal, thereby generating compressed data; and
sending the compressed data to the radio terminal.

2. The method of claim 1, wherein the network node is one of: a Serving Gateway, (SGW) a Packet Data Network Gateway, (PGW), and an Evolved NodeB (eNodeB).

3. The method of claim 1, wherein the network node is one of: a Serving General Packet Service Support Node (SGSN), a Gateway General Packet Service Support Node, (GGSN), a Radio Network Controller, (RNC), and a NodeB.

4. The method of claim 1, wherein the network node is one of: a Serving General Packet Service Support Node (SGSN), a Gateway General Packet Service Support Node (GGSN), a Base Station Controller (BSC), and a Base Transceiver Station (BTS).

5. The method of any claim 1, wherein the request for data is a Hypertext Transfer Protocol, HTTP, request.

6. The method of claim 1, wherein the compression type is any one selected from a group comprising gzip, deflate, and Shared Dictionary Compression over HTTP (SDCH).

7. The method of claim 1, wherein the compression of the received data is performed in connection undertaking Deep Packet Inspection (DPI) at the network node.

8. The method of claim 1, further comprising:
adding information identifying the compression type used by the network node to the compressed data being sent to the radio terminal.

9. A network node configured to compress data intended for a radio terminal in a wireless communications network, said network node handling payload data in a radio access network (RAN) or a core network of the wireless communications network and comprising a processing unit and a memory, said memory containing instructions executable by said processing unit, whereby said network node is operative to:
receive a request from the radio terminal for and an indication of one or more compression types supported by the radio terminal;
forward the request for the-data received from the radio terminal to a provider of the data;
receiving the requested data from the provider of the data;
compressing the received data with a compression type being supported by the radio terminal; and
sending the compressed data to the radio terminal.

10. The network node of claim 9, wherein the network node is one of: a Serving Gateway (SGW) a Packet Data Network Gateway (PGW), and an Evolved NodeB (eNodeB).

11. The network node of claim 9, wherein the network node is one of: a Serving General Packet Service Support Node (SGSN), a Gateway General Packet Service Support Node (GGSN), a Radio Network Controller (RNC), and a NodeB.

12. The network node of claim 9, wherein the network node is one of: a Serving General Packet Service Support Node (SGSN), a Gateway General Packet Service Support Node (GGSN), a Base Station Controller (BSC), and a Base Transceiver Station (BTS).

13. The network node of claim 9, wherein the request is a Hypertext Transfer Protocol (HTTP) request.

14. The network node of claim 9, wherein the compression type is any one selected from a group comprising gzip, deflate, and Shared Dictionary Compression over HTTP.

15. The network node of claim 9, wherein the compression of the received data is performed in connection with undertaking Deep Packet Inspection, at the network node.

16. The network node of claim 9, further being operative to:
add, to the compressed data being sent to the radio terminal, information identifying the compression type used by the network node.

17. A computer program comprising computer-executable instructions for causing a device to perform the method of claim 1 when the computer-executable instructions are executed on a processing unit included in the device.

18. A computer program product comprising a computer readable medium, the computer readable medium having the computer program according to claim 17 embodied therein.
